(19) United States
(12) Patent Application Publication
(10) Pub. No.: US 2026/0312724 A1
(43) Pub. Date: Oct. 8, 2026

(54) ALTERED BASE GRAPH FOR LOW-DENSITY PARITY-CHECK CODE

(71) Applicant: QUALCOMM Incorporated, San Diego, CA (US)

(72) Inventors: Pinar SEN, San Diego, CA (US); Wei YANG, San Diego, CA (US); Jing JIANG, San Diego, CA (US); Thomas Joseph RICHARDSON, South Orange, NJ (US)

(21) Appl. No.: 19/326,306

(22) Filed: Sep. 11, 2025

Related U.S. Application Data
(60) Provisional application No. 63/785,566, filed on Apr. 8, 2025.

(51) Int. Cl. H04L 1/00

(52) U.S. Cl. CPC H04L 1/0057; H04L 1/0041

(57) ABSTRACT

Various aspects of the present disclosure generally relate to wireless communication. In some aspects, a transmitter device may encode, using an altered version of a base graph for a low-density parity-check code, first information to obtain encoded information, wherein the altered version of the base graph includes a set of punctured nodes that are swapped with a set of parity nodes from an unaltered version of the base graph. The transmitter device may modulate the encoded information to map the encoded information to one or more constellation symbols. The transmitter device may transmit, to a receiver device, a signal that indicates second information that is based at least in part on the one or more constellation symbols. Numerous other aspects are described.

### CROSS-REFERENCE TO RELATED APPLICATION

This Patent application claims priority to U.S. Provisional Patent Application No. 63/785,566, filed on Apr. 8, 2025, entitled “ALTERED BASE GRAPH FOR LOW-DENSITY PARITY-CHECK CODE,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with an altered base graph for low-density parity-check code.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

Some aspects described herein relate to a transmitter device for wireless communication. The transmitter device may include one or more memories and one or more processors coupled to the one or more memories. The one or more processors may be configured to encode, using an altered version of a base graph for a low-density parity-check (LDPC) code, first information to obtain encoded information, wherein the altered version of the base graph includes a set of punctured nodes that are swapped with a set of parity nodes from an unaltered version of the base graph. The one or more processors may be configured to modulate the encoded information to map the encoded information to one or more constellation symbols. The one or more processors may be configured to transmit, to a receiver device, a signal that indicates second information that is based at least in part on the one or more constellation symbols.

Some aspects described herein relate to a receiver device for wireless communication. The receiver device may include one or more memories and one or more processors coupled to the one or more memories. The one or more processors may be configured to receive, from a transmitter device, a signal that indicates second information associated with one or more constellation symbols. The one or more processors may be configured to demodulate, based on the one or more constellation symbols, the s information to obtain encoded information. The one or more processors may be configured to decode, using an altered version of a base graph for an LDPC code, the encoded information to obtain first information, wherein the altered version of the base graph includes a set of punctured nodes that are swapped with a set of parity nodes from an unaltered version of the base graph.

Some aspects described herein relate to a method of wireless communication performed by a transmitter device. The method may include encoding, using an altered version of a base graph for an LDPC code, first information to obtain encoded information, wherein the altered version of the base graph includes a set of punctured nodes that are swapped with a set of parity nodes from an unaltered version of the base graph. The method may include modulating the encoded information to map the encoded information to one or more constellation symbols. The method may include transmitting, to a receiver device, a signal that indicates second information that is based at least in part on the one or more constellation symbols.

Some aspects described herein relate to a method of wireless communication performed by a receiver device. The method may include receiving, from a transmitter device, a signal that indicates second information associated with one or more constellation symbols. The method may include demodulating, based on the one or more constellation symbols, the second information to obtain encoded information. The method may include decoding, using an altered version of a base graph for an LDPC code, the encoded information to obtain first information, wherein the altered version of the base graph includes a set of punctured nodes that are swapped with a set of parity nodes from an unaltered version of the base graph.

Some aspects described herein relate to a non-transitory computer-readable medium that stores a set of instructions for wireless communication by a transmitter device. The set of instructions, when executed by one or more processors of the transmitter device, may cause the transmitter device to encode, using an altered version of a base graph for an LDPC code, first information to obtain encoded information, wherein the altered version of the base graph includes a set of punctured nodes that are swapped with a set of parity nodes from an unaltered version of the base graph. The set of instructions, when executed by one or more processors of the transmitter device, may cause the transmitter device to modulate the encoded information to map the encoded information to one or more constellation symbols. The set of instructions, when executed by one or more processors of the transmitter device, may cause the transmitter device to transmit, to a receiver device, a signal that indicates second information that is based at least in part on the one or more constellation symbols.

Some aspects described herein relate to a non-transitory computer-readable medium that stores a set of instructions for wireless communication by a receiver device. The set of instructions, when executed by one or more processors of the receiver device, may cause the receiver device to receive, from a transmitter device, a signal that indicates second information associated with one or more constellation symbols. The set of instructions, when executed by one or more processors of the receiver device, may cause the receiver device to demodulate, based on the one or more constellation symbols, the second information to obtain encoded information. The set of instructions, when executed by one or more processors of the receiver device, may cause the receiver device to decode, using an altered version of a base graph for an LDPC code, the encoded information to obtain first information, wherein the altered version of the base graph includes a set of punctured nodes that are swapped with a set of parity nodes from an unaltered version of the base graph.

Some aspects described herein relate to an apparatus for wireless communication. The apparatus may include means for encoding, using an altered version of a base graph for an LDPC code, first information to obtain encoded information, wherein the altered version of the base graph includes a set of punctured nodes that are swapped with a set of parity nodes from an unaltered version of the base graph. The apparatus may include means for modulating the encoded information to map the encoded information to one or more constellation symbols. The apparatus may include means for transmitting, to a receiver device, a signal that indicates second information that is based at least in part on the one or more constellation symbols.

Some aspects described herein relate to an apparatus for wireless communication. The apparatus may include means for receiving, from a transmitter device, a signal that indicates second information associated with one or more constellation symbols. The apparatus may include means for demodulating, based on the one or more constellation symbols, the second information to obtain encoded information. The apparatus may include means for decoding, using an altered version of a base graph for an LDPC code, the encoded information to obtain first information, wherein the altered version of the base graph includes a set of punctured nodes that are swapped with a set of parity nodes from an unaltered version of the base graph.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example of communication using low-density parity-check (LDPC) codes.

FIG. 3 is a diagram illustrating an example of an LDPC base matrix and an LDPC base graph.

FIG. 4 is a diagram illustrating an example of a parity check matrix associated with an LDPC code.

FIG. 5 is a diagram illustrating an example of lifting for an LDPC code.

FIG. 6 is a diagram illustrating an example of interleaving.

FIG. 7 is a diagram of an example associated with an alteration of a base graph for an LDPC code.

FIG. 8 is a diagram of an example associated with an alteration of a base graph for an LDPC code.

FIG. 9 is a diagram illustrating an example associated with signaling that enables an altered base graph for LDPC code.

FIG. 10 is a diagram illustrating an example process performed, for example, at a transmitter device or an apparatus of a transmitter device.

FIG. 11 is a diagram illustrating an example process performed, for example, at a receiver device or an apparatus of a receiver device.

FIG. 12 is a diagram of an example apparatus for wireless communication.

FIG. 13 is a diagram of an example apparatus for wireless communication.

### DETAILED DESCRIPTION

Low density parity check (LDPC) codes are linear block codes that may be used to provide forward error correction capabilities in a communication system with a performance that approaches channel capacity. The performance may be achieved under an iterative belief propagation decoding scheme, also known as message-passing decoding, which has a linear complexity associated with an LDPC code block length. In particular, LDPC codes are defined or represented according to a sparse parity check matrix (PCM) that typically has a low density of entries with a value of 1. From a transmitter perspective, the transmitter (or LDPC encoder) multiplies one or more systematic bits or information bits by a PCM to generate a code block (or codeword). The sparse PCM generally includes a systematic submatrix and a parity submatrix. The parity submatrix may be inverted to compute a parity vector used to encode an LDPC code. In some cases, as a result of the sparseness, the parity submatrix portion of the PCM may have a structure that makes the complexity of the parity submatrix inversion prohibitive as code block length increases. Accordingly, LDPC codes may utilize an accumulative chain structure, also known as a degree-2 chain structure, to simplify the encoding. Furthermore, in some cases, an LDPC code may be quasi-cyclic. For example, as described herein, a quasi-cyclic LDPC (QC-LDPC) code is associated with a base graph and lifting values that provide a compact PCM representation, which enables efficient encoding and high parallelism in a decoder architecture.

Systematic bit priority mapping (SBPM) is a technique to map systematic bits of a communication to the most significant bits of each modulated symbol of the communication. This increases reliability due to an increased likelihood of correct demodulation of the systematic bits because the most significant bits (e.g., the most significant bit, or one or more most significant bits) of the modulated symbol have increased protection against errors as compared to the least significant bits (e.g., the least significant bit, or one or more least significant bits) of the modulated symbol when using conventional modulation constellations, such as phase-shift keying (PSK) or quadrature amplitude modulation (QAM). For example, even if a receiver incorrectly demodulates a modulated symbol, that incorrect demodulation is likely to correspond to a constellation point, in a constellation diagram for the conventional modulation scheme, that is near the correct constellation point and that has one or more most significant bits in common with the correct constellation point. SBPM may be referred to as a bit-to-modulation mapping technique. For example, SBPM may be a technique for mapping coded bits to modulation constellation symbols for over-the-air transmission.

In some aspects, block interleaving (e.g., SBPM interleaving) may be performed using a technique called write by row, read by column. Using this technique, bits may be obtained from a circular buffer as part of a rate matching process, with a starting bit determined based at least in part on a redundancy version, of the communication, to be transmitted. As the bits are obtained, those bits may be written to blocks across a first row, where each bit is placed in a different column corresponding to a different symbol. After the first row is filled, bits may be written to blocks across a second row, and so on. The starting bit and a set of subsequent bits of the circular buffer may be systematic bits, and may be followed by parity bits. As a result, the first one or more rows may include systematic bits, and the last one or more rows may include parity bits.

Because the first row(s) correspond to more significant bits (e.g., most significant bits (MSBs)) of the modulated symbol and the last row(s) correspond to less significant bits (e.g., least significant bits (LSBs)) of the modulated symbol, this technique may map systematic bits (e.g., some, most, or all of the systematic bits, depending on a starting bit in the circular buffer) to the most significant bit(s) of the modulated symbol, thereby increasing reliability, as described above. After all of the coded bits are written to the blocks (referred to as “interleaving”), those interleaved bits are read from the blocks down a first column as input to a modulation process to modulate those coded bits in a modulated symbol. After modulation, the coded bits in the first column will be represented as a first modulated symbol, the coded bits in a second column will be represented as a second modulated symbol, and so on. In some aspects, the interleaving or the modulation may be performed to first map the modulated symbols to a layer (e.g., a multiple-input multiple-output (MIMO) layer), then map the modulated symbols to a frequency, and then map the modulated symbols to time. In this way, protection from burst errors may be enhanced.

As an example, an SBPM scheme may enable a transmitter to map the systematic portion of coded bits (e.g., LDPC coded bits) to the MSB of a modulation constellation, and to map the non-systematic portion to the LSB of the modulation constellation. Without applying SBPM, each variable node in the base graph may experience, on average, the same channel conditions or reliabilities. As a result of applying SBPM, copies of the same variable node in a base graph may be associated with similar channel reliabilities, and different variable nodes in the base graph may experience different channel reliabilities. By improving a likelihood of copies of the same variable node in a base graph being associated with similar channel reliabilities (e.g., by mapping them consistently to the MSB or LSB, for example), the SBPM scheme may improve a decoding threshold for a channel coding scheme, such as the QC-LDPC coding scheme described herein.

However, an SBPM scheme can result in performance degradation in some scenarios, such as high throughput scenarios (e.g., throughputs above 100 gigabits per second). For example, an SBPM scheme may result in degraded performance for transport block sizes near a switch point between two base graphs for an LDPC code. The switch point may be a threshold transport block size. For example, if a transport block has a size less than the threshold transport block size, a transmitter may encode the transport block using a first base graph. If the transport block has a size greater than the threshold transport block size, the transmitter may encode the transport block using a second base graph. For transport block sizes near the switch point, data encoded using the first base graph may experience worse performance (e.g., worse signal-to-noise ratio (SNR) performance) than data encoded using the second base graph (e.g., there may be a jump in performance near the switch point when switching to the second base graph). The jump or increase in performance may be caused by the SBPM scheme, rather than the LDPC encoding. Such jumps or increases in SNR performance may cause degraded performance for communications between the transmitter and the receiver because fluctuations in SNR conditions can cause the decoding processing to degrade, increasing the risk of decoding errors, among other examples.

Additionally, or alternatively, the SBPM scheme may be associated with a higher error floor (e.g., a higher minimum block error rate supported). For example, SBPM may result in degraded performance in low error rate scenarios. In an LDPC encoding scheme that uses an accumulative (or degree-2) chain structure to reduce encoding complexity, degree-2 nodes may have an adverse impact on the error floor performance for the resulting LDPC codes. As another example, for a probabilistic shaping system that uses QC-LDPC codes, SBPM may be inapplicable because SBPM may result in parity bits being mapped to an LSB. For a probabilistic shaping system, a uniform distribution (e.g., a uniform probability distribution) of the parity bits should be preserved in order to preserve a zero mean property of the constellation. However, if parity bits are mapped to LSBs, the zero mean property of the constellation may be lost.

Various aspects relate generally to enhancing wireless communication performance, using an altered version of a base graph for LDPC code. For example, the altered base graph includes a set of punctured nodes (or punctured columns) that are swapped with a set of parity nodes (or parity columns) from the original base graph. This alteration is aimed at improving the reliability of transmitted data at high modulation orders, such as 64-QAM and 256-QAM, which may be susceptible to higher error floors due to the mapping of bits in the SBPM scheme. In some aspects, the transmitter device may modulate and map the encoded information to one or more constellation symbols, leveraging the altered base graph structure to ensure that parity bits, particularly swapped degree-2 parity nodes, are positioned in the MSB locations of the modulation constellation. The signal, which includes this encoded and modulated information, may then be transmitted to a receiver device, potentially alongside capability or configuration information that indicates support for using the altered base graph for both encoding and decoding processes.

Particular aspects of the subject matter described in this disclosure can be implemented to realize one or more of the following potential technical benefits. By encoding information using an altered base graph where critical nodes are swapped to enhance bit protection, the described techniques can be used to significantly reduce error floors, leading to a more efficient utilization of spectrum resources and increased data transmission reliability. For example, by the transmitter device placing one or more parity columns at the start of the altered base graph, the likelihood may increase for the transmitter device to map and transmit the parity bits (e.g., in the one or more parity columns) in MSB locations of constellation symbols after applying the depth-m block interleaver. In some examples, the parity bits may be associated with variable nodes that impact the error floor of the LDPC code. For example, by the transmitter device encoding the information using the altered base graph, the transmitter may encode and map bits that impact the performance of the LDPC code (e.g., certain degree-2 parity nodes in the base graph) to MSB locations in a constellation symbol, thereby improving the performance of the LDPC code. Furthermore, communication of capability or configuration information ensures that both the transmitter and receiver devices operate in synchronization with the LDPC encoding/decoding using the altered base graph, which may conserve processing resources by avoiding decoding errors that would have otherwise resulted from the usage of incompatible base graphs.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

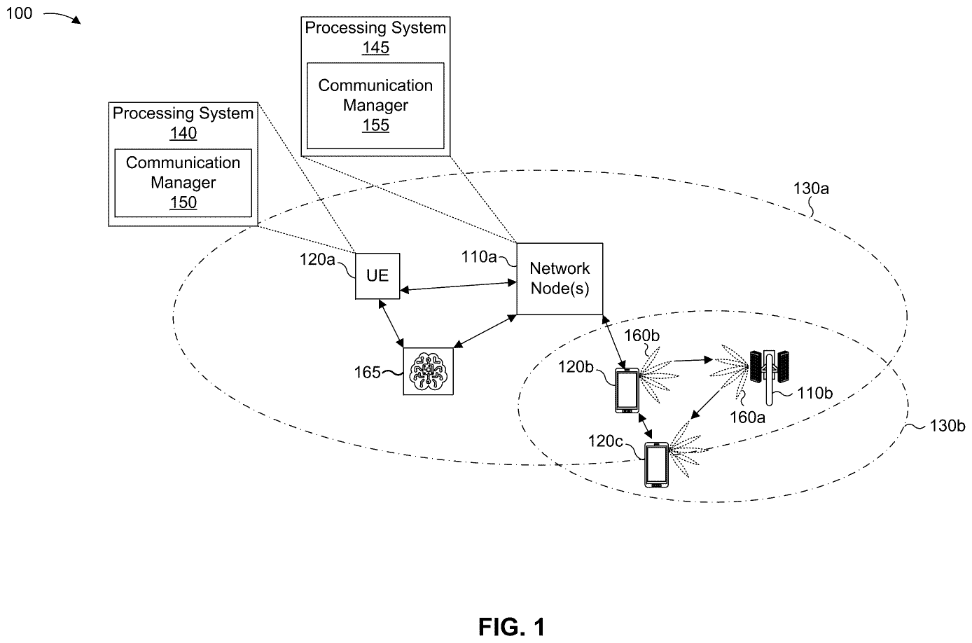

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a transmitter device (e.g., a UE 120 or a network node 110) may include a communication manager 150 or 155. As described in more detail elsewhere herein, the communication manager 150 or 155 may encode, using an altered version of a base graph for an LDPC code, first information to obtain encoded information, wherein the altered version of the base graph includes a set of punctured nodes that are swapped with a set of parity nodes from an unaltered version of the base graph; modulate the encoded information to map the encoded information to one or more constellation symbols; and transmit, to a receiver device, a signal that indicates second information that is based at least in part on the one or more constellation symbols. Additionally, or alternatively, the communication manager 150 or 155 may perform one or more other operations described herein.

In some aspects, a receiver device (e.g., a UE 120 or a network node 110) may include a communication manager 150 or 155. As described in more detail elsewhere herein, the communication manager 150 or 155 may receive, from a transmitter device, a signal that indicates second information associated with one or more constellation symbols; demodulate, based on the one or more constellation symbols, the second information to obtain encoded information; and decode, using an altered version of a base graph for an LDPC code, the encoded information to obtain first information, wherein the altered version of the base graph includes a set of punctured nodes that are swapped with a set of parity nodes from an unaltered version of the base graph. Additionally, or alternatively, the communication manager 150 or 155 may perform one or more other operations described herein.

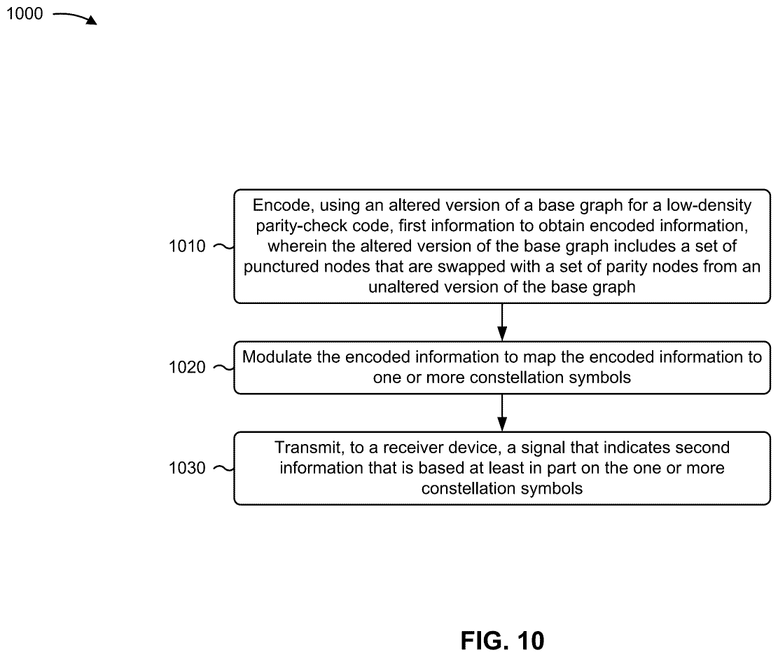

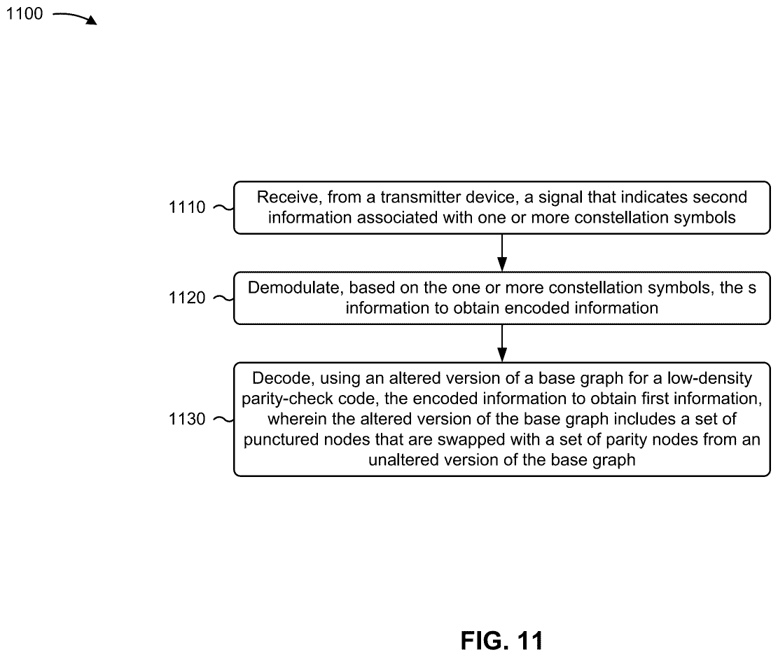

The network node 110, the processing system 145 of the network node 110, the UE 120, the processing system 140 of the UE 120, or any other component(s) of FIG. 1 may implement one or more techniques or perform one or more operations associated with an altered base graph for LDPC code, as described in more detail elsewhere herein. For example, the processing system 145 of the network node 110, or the processing system 140 of the UE 120 may perform or direct operations of, for example, process 1000 of FIG. 10, process 1100 of FIG. 11, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 1000 of FIG. 10, process 1100 of FIG. 11, or other processes as described herein. In some examples, executing instructions may include running the instructions, converting the instructions, compiling the instructions, or interpreting the instructions, among other examples.

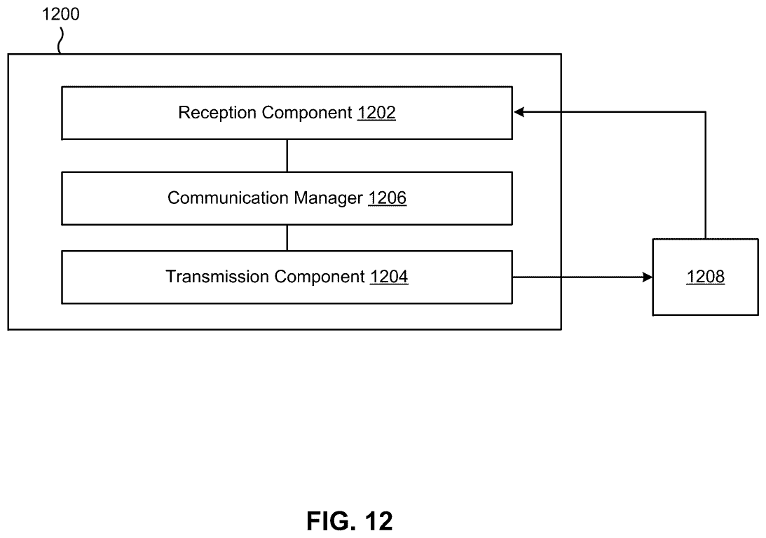

In some aspects, a transmitter device (e.g., a UE 120 or a network node 110) includes means for encoding, using an altered version of a base graph for an LDPC code, first information to obtain encoded information, wherein the altered version of the base graph includes a set of punctured nodes that are swapped with a set of parity nodes from an unaltered version of the base graph; means for modulating the encoded information to map the encoded information to one or more constellation symbols; or means for transmitting, to a receiver device, a signal that indicates second information that is based at least in part on the one or more constellation symbols. In some aspects, the means for the transmitter device to perform operations described herein may include, for example, one or more of communication manager 150, communication manager 155, processing system 140, processing system 145, a radio, one or more RF chains, one or more transceivers, one or more antennas, one or more modems, a reception component (for example, reception component 1202 depicted and described in connection with FIG. 12), or a transmission component (for example, transmission component 1204 depicted and described in connection with FIG. 12), among other examples.

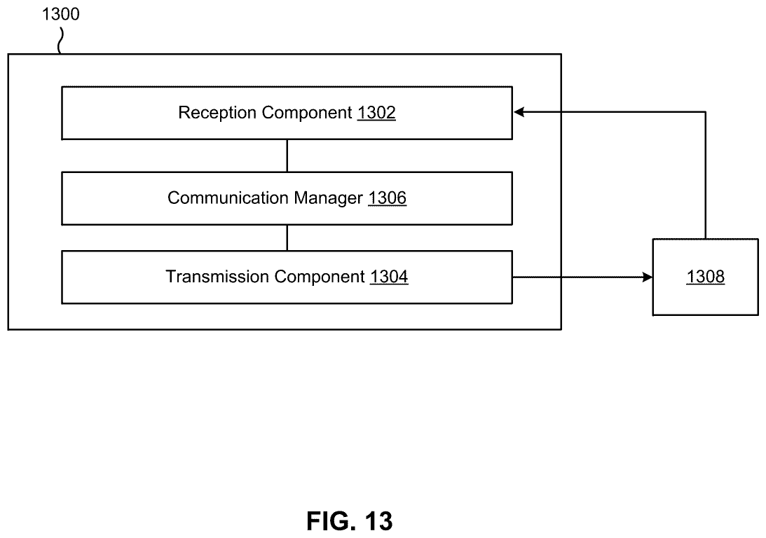

In some aspects, a receiver device (e.g., a UE 120 or a network node 110) includes means for receiving, from a transmitter device, a signal that indicates second information associated with one or more constellation symbols; means for demodulating, based on the one or more constellation symbols, the second information to obtain encoded information; or means for decoding, using an altered version of a base graph for an LDPC code, the encoded information to obtain first information, wherein the altered version of the base graph includes a set of punctured nodes that are swapped with a set of parity nodes from an unaltered version of the base graph. In some aspects, the means for the transmitter device to perform operations described herein may include, for example, one or more of communication manager 150, communication manager 155, processing system 140, processing system 145, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

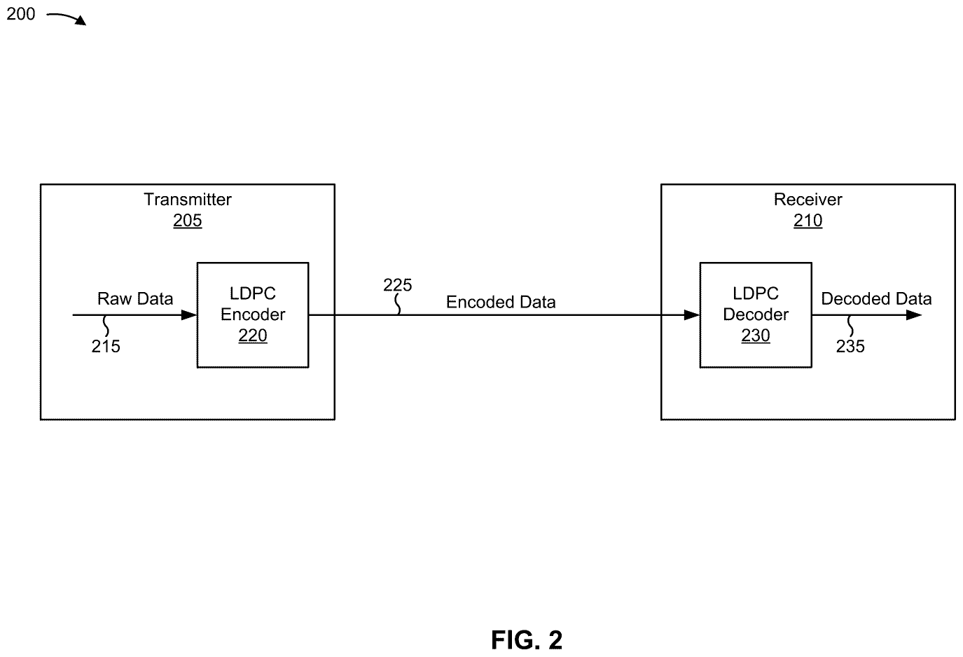

FIG. 2 is a diagram illustrating an example 200 of communication using LDPC codes. As shown in FIG. 2, example 200 includes communication between a first wireless device (e.g., a UE 120, a network node 110, among other examples), shown in FIG. 2 and referred to herein as transmitter 205, and a second wireless device (e.g., a UE 120, a network node 110, among other examples), shown in FIG. 2 and referred to herein as receiver 210. As shown in FIG. 2, the transmitter 205 includes an LDPC encoder 220 and the receiver 210 includes an LDPC decoder 230, which the transmitter 205 and the receiver 210 may use to implement an LDPC channel coding scheme in which LDPC codes are used for one or more data channel transmissions. For example, in some aspects, the transmitter 205 may correspond to a network node 110 and the receiver 210 may correspond to a UE 120, and the LDPC channel coding scheme may be used for one or more PDSCH transmissions from the network node 110 to the UE 120. Additionally, or alternatively, the transmitter 205 may correspond to a UE 120 and the receiver 210 may correspond to a network node 110, and the LDPC channel coding scheme may be used for one or more PUSCH transmissions from the UE 120 to the network node 110. Additionally, or alternatively, the transmitter 205 may correspond to a first UE 120 and the receiver 210 may correspond to a second UE 120, and the LDPC channel coding scheme may be used for one or more physical sidelink shared channel (PSSCH) transmissions from the first UE 120 to the second UE 120. In some aspects, the transmitter 205 and the receiver 210 may communicate in a wireless network, such as the wireless communication network 100.

In some aspects, a communication from the transmitter 205 to the receiver 210 may be encoded based at least in part on an error correcting code (sometimes referred to as an error correcting scheme), such that the receiver 210 can determine whether the communication was properly transmitted (e.g., to verify that the communication was not corrupted by noise or the like) or so that the receiver 210 can correct any transmission errors using redundant bits provided by the error correcting code. One example of an error correcting code is an LDPC code. A communication may be encoded according to an LDPC channel coding scheme to provide for error detection at the receiver 210. Encoding for an LDPC code may be performed based at least in part on a base graph (e.g., a sparse bipartite graph) that may identify a codeword to be generated from an input data set or information to append to an input data set to form the LDPC code.

More particularly, as shown in FIG. 2, the transmitter 205 may be in wireless communication with the receiver 210. When the transmitter 205 transmits data to the receiver 210, the transmitter 205 may first encode the data using an error correcting code, such as an LDPC code. For example, as shown in FIG. 2, the transmitter 205 may process raw data 215 (e.g., information bits) to be transmitted to the receiver 210 by feeding the raw data 215 through the LDPC encoder 220, among other signal processing components. The transmitter 205 may perform other signal processing operations (e.g., interleaving or the like), which are not shown in FIG. 2. The LDPC encoder 220 may add error correction bits (e.g., parity bits) to the raw data 215 based at least in part on a selected base graph or based at least in part on a target code rate, forming an encoded data stream 225. In some examples, the target code rate may be expressed as R=k/n, where R is the target code rate, k is a number of information bits in the raw data 215 input to the LDPC encoder 220, and n is a total number of bits in the encoded data stream transmitted to the receiver 210 (e.g., the target code rate is the proportion of the encoded data stream 225 that is useful, or non-redundant). For example, LDPC codes associated with a lower code rate provide more error protection, but may incur more overhead, relative to LDPC codes with a higher code rate.

As further shown in FIG. 2, the transmitter 205 may transmit the encoded data stream 225 to the receiver 210 over a wireless link (e.g., a wireless access link for uplink or downlink communication, or a wireless sidelink for sidelink communication), where the encoded data stream 225 is fed through the LDPC decoder 230 (and, in some examples, other signal processing components such as a de-interleaver, among other examples) in order to recover the information bits from decoded data 235 output from the LDPC decoder 230. For example, the LDPC decoder 230 may use an iterative belief propagation decoding scheme (also known as a message passing decoding scheme) to decode the encoded data stream 225.

As indicated above, FIG. 2 is provided as an example. Other examples may differ from what is described with regard to FIG. 2.

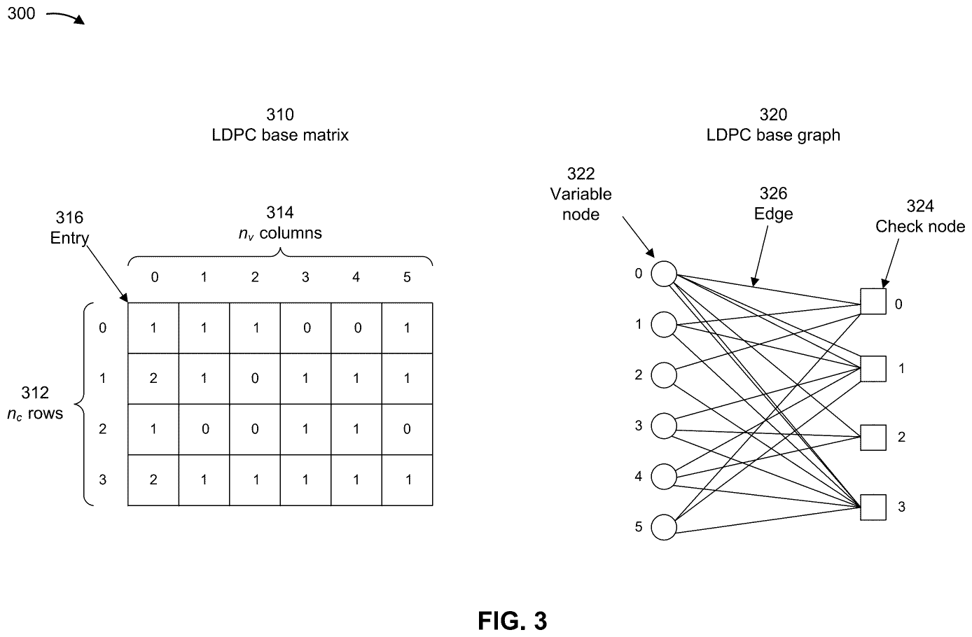

FIG. 3 is a diagram illustrating an example 300 of an LDPC base matrix 310 and an LDPC base graph 320. As described herein, the LDPC base matrix 310 and the LDPC base graph 320 may be used to encode an LDPC code, which is a linear block code that can provide error correction capabilities that may be close to channel capacity. For example, the LDPC base matrix 310 and the LDPC base graph 320 may be used by the LDPC encoder 220 of the transmitter 205 to encode the raw data 215 (e.g., to generate the encoded data stream 225). In some examples, an LDPC code may be represented according to a base graph (for example, a sparse bipartite graph) that may identify a codeword to be generated from an input data set or information to append to an input data set to form the LDPC code. For example, a bipartite graph may include variable nodes representing information bits (also known as message bits or systematic bits) and check nodes representing parity-check equations. The edges between the variable nodes and the check nodes may define how the information bits are related through the parity-check equations, which may be solved using the input data set to determine the values of the parity bits. For example, the original information bits may be combined with the parity bits to form an LDPC code containing the input data (information bits) and the error-correcting (parity) bits.

As shown in FIG. 3, the LDPC base matrix 310 has a size n_{c}×nᵥ including a total number of n_{c} rows 312 and a total number of nᵥ columns 314. Additionally, both n_{c} and nᵥ are positive integers, and the total number of rows n_{c} may be smaller than the total number of columns nᵥ. Each entry 316 of the LDPC base matrix 310 is a non-negative integer in a set of integers ranging from 0 to a bounded integer that is independent of the size of the LDPC base matrix 310. For example, the set of integers may be {0,1}, {0,1,2}, or {0,1,2, . . . , dₘₐₓ} for some dₘₐₓ integer. Additionally, each row 312 of the LDPC base matrix 310 may be indexed by a respective integer from 0 to n_{c}−1. Each column 314 of the LDPC base matrix 310 may be indexed by a respective integer from 0 to nᵥ−1.

As further shown in FIG. 3, the LDPC base matrix 310 is associated with an LDPC base graph 320 that represents the LDPC base matrix 310. In some examples, the LDPC base graph 320 may be a bipartite graph including a set of variable nodes 322, a set of check nodes 324, and a set of edges 326 connecting the set of variable nodes 322 and the set of check nodes 324. For example, each variable node 322 may be labelled by a respective integer from 0 to nᵥ−1, such that each variable node 322 corresponds to a column 314 of the LDPC base matrix 310. Furthermore, each check node 324 may be labelled by a respective integer from 0 to n_{c}−1, such that each check node 324 corresponds to a row 312 of the LDPC base matrix 310. Additionally, an edge 326 exists between a variable node i and a check node a if a value of the entry at (column a, row i) of the LDPC base matrix 310 is non-zero, and the number of edges between the variable node i and the check node a is equal to the value of the entry at (column a, row i) in the LDPC base matrix 310. For example, the entry at (column 0, row 0) of the LDPC base matrix 310 has a value of 1, which is represented in the edge 326 between variable node 0 and check node 0. Furthermore, a variable node 322 is a state node if a corresponding column 314 of the LDPC base matrix 310 is a state column. In addition, a state variable or state column may refer to a variable node of an LDPC code associated with a transmitted (e.g., punctured) set of information bits.

As indicated above, FIG. 3 is provided as an example. Other examples may differ from what is described with regard to FIG. 3.

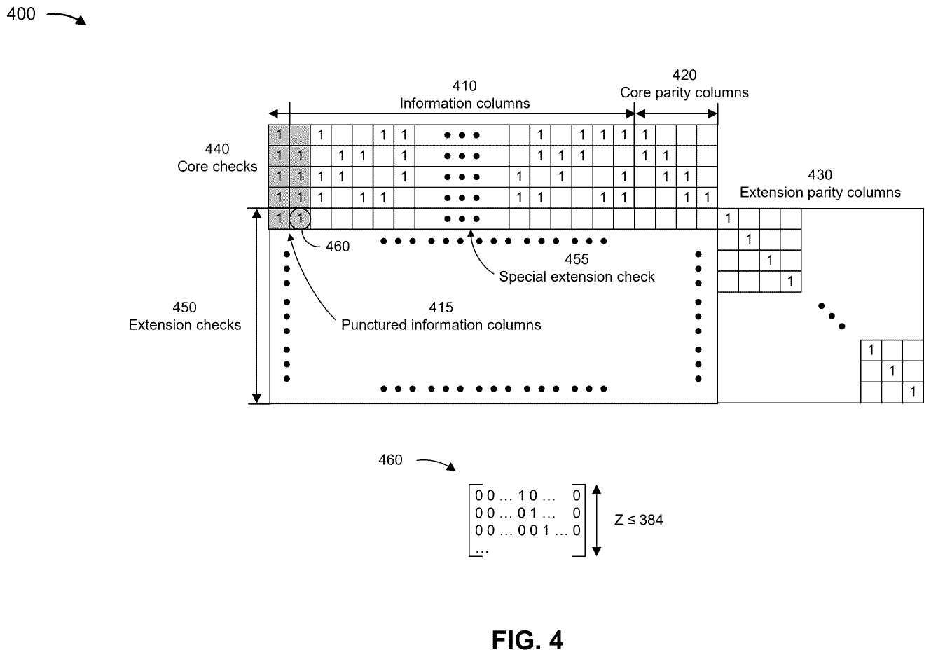

FIG. 4 is a diagram illustrating an example 400 of a PCM associated with an LDPC code. As described herein, the PCM shown in FIG. 4 may be used for a QC-LDPC code, where the PCM has a compact representation that may enable efficient LDPC encoding and high parallelism in a corresponding LDPC decoder architecture. In some examples, the PCM shown in FIG. 4 may be used by the transmitter 205 to encode the raw data 215 via the LDPC encoder 220. Similarly, the PCM shown in FIG. 4 may be used by the receiver 210 to decode the encoded data stream 225 via the LDPC decoder 230.

For example, the PCM is a set of codewords that satisfy one or more parity check conditions, which may be defined according to a base graph and lifting values (also known as a protograph LDPC code). In particular, as described herein, the base graph (or protograph) is a small graph that captures macroscopic properties associated with the QC-LDPC code, such as a decoding threshold. After the base graph has been constructed, a lifting procedure is applied in which the base graph is copied multiple times and connections between different copies of the base graph are permuted to construct one larger graph. Otherwise, without permuting the different copies of the base graph into one larger graph, there would be K small graphs that are not connected to each other, which may result in no coding gain. The copying and permutation is a cyclic permutation along edges of the base graph, and is generally known as cyclic shift lifting. Accordingly, the LDPC code resulting from the encoding procedure of constructing the base graph and applying the lifting procedure is known as a QC-LDPC code.

In some examples, the base graph associated with an LDPC code (such as the LDPC base graph 320) may be described or represented as a matrix (or base matrix), such as the PCM shown in example 400. For example, as shown in FIG. 4, the PCM includes a set of information columns 410, a set of core parity columns 420, and a set of extension parity columns 430, which represent variable nodes associated with the PCM. In addition, the PCM includes a set of core check rows 440 and a set of extension check rows 450, which represent check nodes associated with the PCM. The extension check rows 450 include a special extension check 455, and the information columns include one or more punctured information columns 415. For each entry in the PCM, the value is a non-negative integer representing the number of connections between the variable node and the check node corresponding to the entry (e.g., a 0 means that there is no connection between the corresponding variable node and check node, a 1 means that there is 1 edge connecting the corresponding variable node and check node, a 2 means that there are 2 edges connecting the corresponding variable node and check node, and so on). As described herein, each variable node has a degree that denotes the number of check nodes that the variable node is connected to in the base graph (e.g., the number of rows with a positive value), where a degree-n variable node is connected to n check nodes. The extension check rows 450 include a special extension check 455, and the information columns include one or more punctured information columns 415.

As further shown in FIG. 4, and by reference number 460, each entry that has a positive value (e.g., one) may be replaced by a permuted identity matrix that indicates the number of cyclic permutations applied to each edge in the base graph. The lifting values may be integers in a range between 0 and Z, where Z is a lifting factor (e.g., the number of copies that are applied to the base graph). Accordingly, after constructing the base graph and applying the lifting procedure, the resulting QC-LDPC code has a block length equal to the size of the base graph multiplied by the lifting factor.

As indicated above, FIG. 4 is provided as an example. Other examples may differ from what is described with regard to FIG. 4.

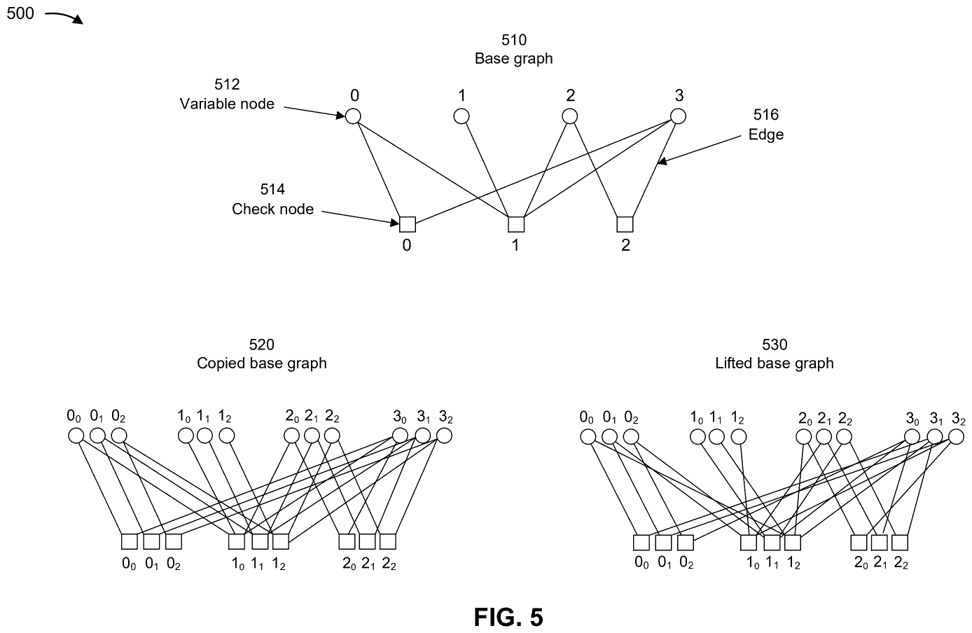

FIG. 5 is a diagram illustrating an example 500 of lifting for an LDPC code. As described herein, an LDPC code is a binary linear block code over a finite field [symbol] , and protograph-based QC-LDPC codes are a type of LDPC code used in various communication systems (e.g., NR, Wi-Fi, and Ethernet). For example, to generate a QC-LDPC code, a cyclic lifting operation may be performed over a base graph 510 (e.g., the LDPC base graph 320) or a protograph to generate a lifted base graph 530 by taking Z copies of the base graph 510. For example, the Z copies of the base graph 510 may be taken to generate a copied base graph 520, which includes one or more copies of each variable node 512, each check node 514, and each accompanying edge 516 in the base graph 510 or protograph. In some examples, Z is a lifting factor selected from a set of lifting factors, which may determine how many bits are represented for each bit in the original code. The Z like or similar edges of the copied base graph 520 may be connected through respective cyclic permutations to generate the lifted base graph 530.

For example, the Z graphs in the copied base graph 520 are interconnected to form a larger graph in which each variable node 512 in one copy of the base graph 510 (in the copied base graph 520) is connected to a check node 514 in another copy of the base graph 510 only if the variable node 512 is connected to the check node 514 in the original base graph 510. In other words, for each variable node 512 and check node 514 that are connected in the base graph 510, the Z edges 516 are permuted among the variable nodes 512 and the check nodes 514 that correspond to the same variable node 512 and check node 514 in the base graph 510. Furthermore, to reduce encoding and decoding complexity, the permuting operation may be limited to cyclic lifting, where the permutation is a cyclic shift (e.g., where each non-zero entry in the base graph 510 is replaced with a Z×Z circulant matrix, as shown in FIG. 4). Accordingly, in a QC-LDPC code, each edge 516 in the base graph 510 may have a cyclic shift value.

In some examples, the lifted base graph 530 indicates a lifted PCM and an associated QC-LDPC code. In some examples, one or more telecommunications standards may define an LDPC code design that includes QC-LDPC codes with two base graphs (for example, BG1 and BG2) and a cluster of sets of lifting factors. In some examples, a cyclically lifted LDPC code over [symbol] , based on an LDPC base matrix or an LDPC base graph (such as base graph 510), can be represented as a code over a group ring [symbol] [x] that may include all binary polynomials modulo x^{Z}+1 over [symbol] . In this representation, each variable node 512 in the base graph 510 can be represented as a binary polynomial b=b₀+b₁x+b₂x²+ . . . +b_{Z-1}x^{Z-1}, where [b₀, . . . , b_{Z-1}] denotes the Z bits associated with Z variable nodes 512 in the lifted base graph 530. Furthermore, cyclically shifting the vector [b₀, . . . , b_{Z-1}] by an element t is equivalent to multiplying the polynomial b by x^{t}. Accordingly, a PCM with lifting values may be represented as

$$[ \begin{matrix}{x}^{{a}_{00}} & 0 & {x}^{{a}_{02}} & 0 \\ 0 & {x}^{{a}_{11}} & {x}^{{a}_{12}} & {x}^{{a}_{13}} \\ {x}^{{a}_{20}} & {x}^{{a}_{21}} & {x}^{{a}_{22}} & 0 \\ {x}^{{a}_{30}} & {x}^{{a}_{31}} & 0 & {x}^{{a}_{33}}\end{matrix} ] ,$$

or equivalently represented as

$$[ \begin{matrix}{a}_{00} & - 1 & {a}_{02} & - 1 \\ - 1 & {a}_{11} & - 1 & {a}_{13} \\ {a}_{20} & {a}_{21} & {a}_{22} & - 1 \\ {a}_{30} & {a}_{31} & - 1 & {a}_{33}\end{matrix} ] ,$$

where aᵢⱼ∈{0, . . . , Z−1} denotes the lifting values (or cyclic shift values) and a −1 value denotes no edge between the variable node and the check node (e.g., no edge 516 between the variable node 512 and the check node 514 in the base graph 510 or the lifted base graph 530). For example, the above representations indicate that the first edge (the entry in the upper-left corner) is cyclically shifted by an integer a₀₀, and the last edge (the entry in the lower-right corner) is cyclically shifted by an integer a₃₃.

The LDPC polynomial matrix code contains the set of all length-nᵥ vectors over [symbol] F_{Z}[x], C(x), such that H(x)C(x)≡0, where H(x) is an LDPC polynomial matrix of size n_{c}×nᵥ over [symbol] _{Z}[x]. Each entry of the LDPC polynomial matrix may be a polynomial in [symbol] _{Z}[x], and the number of non-zero terms of the polynomial may be given by the corresponding entry of the base matrix, where each exponent of the polynomial may be referred to as a cyclic shift value. Additionally, a lifted LDPC matrix, denoted H, may be defined by replacing each element of the LDPC base matrix by a respective permutation matrix of size Z×Z, where the amount (e.g., sum) of permutations is indicated by the respective exponents of the LDPC polynomial matrix. For example, an LDPC polynomial matrix, denoted H(x), may have a one-to-one correspondence with a lifted LDPC matrix H and may specify a lifted LDPC code over [symbol] .

As indicated above, FIG. 5 is provided as an example. Other examples may differ from what is described with regard to FIG. 5.

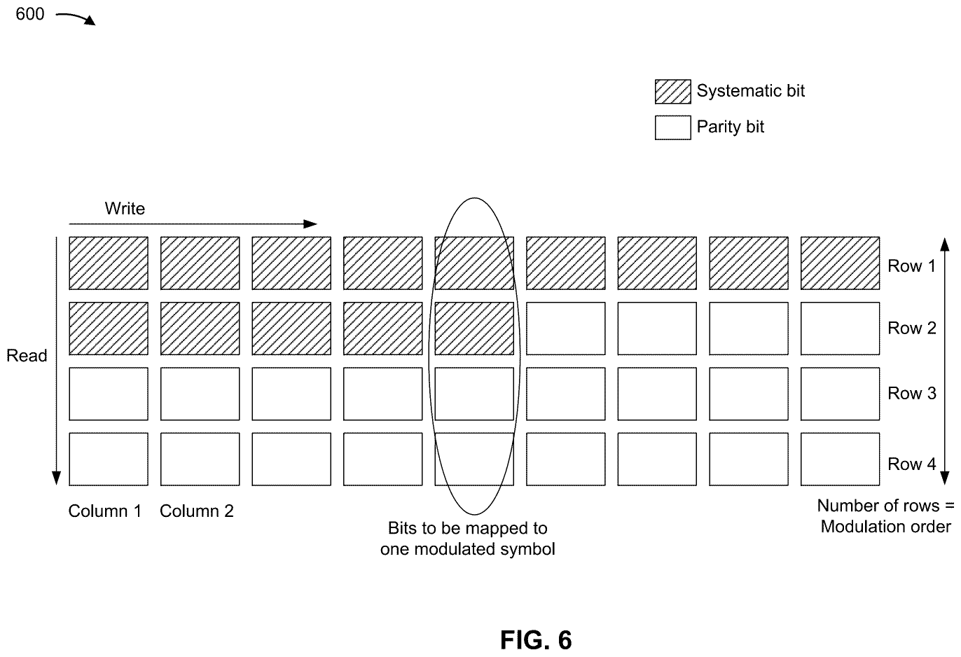

FIG. 6 is a diagram illustrating an example 600 of interleaving. In some examples, interleaving may be performed after (or as the last step of) rate matching to map bits to symbols for modulation. Interleaving may improve reliability of a transmitted communication by, for example, improving robustness of forward error correction at a receiver, such as the receiver 210. For example, interleaving may result in bits, which are consecutive prior to interleaving, being spaced out (e.g., in MIMO layers, frequency, or time) such that some of those bits are no longer consecutive. This may mitigate the effects of burst errors, thereby reducing local gaps in communications, such as gaps in voice, video, data, or other communications.

A communication transmitted over the air may include systematic bits (e.g., also referred to as information bits or message bits) and parity bits (e.g., also referred to as check bits), which together form coded bits (e.g., a codeword) of the communication. The systematic bits may carry the information to be conveyed, and the parity bits may be used for error detection or error correction (e.g., using a checksum, or a cyclic redundancy check). In some aspects, the parity bits are a function of or determined based at least in part on the systematic bits.

SBPM is a technique to map systematic bits of a communication to the most significant bits of each modulated symbol of the communication. This increases reliability due to an increased likelihood of correct demodulation of the systematic bits because the most significant bits (e.g., the most significant bit, or one or more most significant bits) of the modulated symbol have increased protection against errors as compared to the least significant bits (e.g., the least significant bit, or one or more least significant bits) of the modulated symbol when using conventional modulation constellations, such as PSK or QAM. For example, even if a receiver incorrectly demodulates a modulated symbol, that incorrect demodulation is likely to correspond to a constellation point, in a constellation diagram for the conventional modulation scheme, that is near the correct constellation point and that has one or more most significant bits in common with the correct constellation point. SBPM may be referred to as a bit-to-modulation mapping technique. For example, SBPM may be a technique for mapping coded bits (e.g., bits from the encoded data stream 225) to modulation constellation symbols for over-the-air transmission.

An example of SBPM interleaving (e.g., using block interleaving) is shown in FIG. 6. In some examples, SBPM interleaving may be referred to as a depth-m block interleaving. In example 600, each block represents a bit, which may be a systematic bit or a parity bit, as shown. A column of blocks represents a number of bits that are mapped to a single symbol (e.g., a single modulated symbol). The number of bits (e.g., the number of rows in a column) is equal to the modulation order. Thus, interleaving may be a function of modulation order. In example 600, each modulated symbol represents 4 bits, which has a modulation order of 4 (e.g., 4 bits per symbol). The number of columns may depend on the size of the communication to be transmitted. For example, the number of columns may be equal to the total number of coded bits (e.g., systematic bits plus parity bits) to be transmitted, divided by the modulation order. In example 600, there are 36 coded bits to be transmitted with a modulation order of 4, leading to 9 columns of blocks.

In some aspects, block interleaving (e.g., SBPM interleaving) may be performed using a technique called write by row, read by column. Using this technique, bits may be obtained from a circular buffer as part of a rate matching process, with a starting bit determined based at least in part on a redundancy version, of the communication, to be transmitted. As the bits are obtained, those bits may be written to blocks across a first row (shown as row 1), where each bit is placed in a different column corresponding to a different symbol. After the first row is filled, bits may be written to blocks across a second row (shown as row 2), and so on. The starting bit and a set of subsequent bits of the circular buffer may be systematic bits, and may be followed by parity bits. As a result, the first one or more rows (shown toward the top of FIG. 6) may include systematic bits, and the last one or more rows (shown toward the bottom of FIG. 6) may include parity bits.

Because the first row(s) correspond to more significant bits (e.g., MSBs) of the modulated symbol and the last row(s) correspond to less significant bits (e.g., LSBs) of the modulated symbol, this technique may map systematic bits (e.g., some, most, or all of the systematic bits, depending on a starting bit in the circular buffer) to the most significant bit(s) of the modulated symbol, thereby increasing reliability, as described above. In example 600, the first row corresponds to the MSB of the modulated symbol, and is filled entirely with systematic bits, and the last row corresponds to the LSB of the modulated symbol, and is filled entirely with parity bits.

After all of the coded bits are written to the blocks, referred to as interleaving, those interleaved bits are read from the blocks down a first column (e.g., shown as column 1) as input to a modulation process to modulate those coded bits in a modulated symbol. After modulation, the coded bits in the first column will be represented as a first modulated symbol, the coded bits in a second column (e.g., shown as column 2) will be represented as a second modulated symbol, and so on. In some aspects, the interleaving or the modulation may be performed to first map the modulated symbols to a layer (e.g., a MIMO layer), then map the modulated symbols to a frequency, and then map the modulated symbols to time. In this way, protection from burst errors may be enhanced.

As an example, an SBPM scheme may enable a transmitter (e.g., the transmitter 205 via the LDPC encoder 220) to map the systematic portion of coded bits (e.g., LDPC coded bits) to the MSB of a modulation constellation, and to map the non-systematic portion to the LSB of the modulation constellation. Without applying SBPM, each variable node in the base graph may experience, on average, the same channel conditions or reliabilities. As a result of applying SBPM, copies of the same variable node in a base graph (such as a variable node 512 in the base graph 510) may be associated with similar channel reliabilities and different variable nodes in the base graph may experience different channel reliabilities. For example, in the lifted base graph 530 depicted in FIG. 5, the variable nodes 0₀, 0₁, and 0₂ may be mapped to an MSB and the variable nodes 3₀, 3₁, and 3₂ may be mapped to an LSB. Without SBPM, the variable nodes 0₀, 0₁, 3₁, and 3₂ may be mapped to one modulation constellation symbol (e.g., one QAM symbol). By improving a likelihood of copies of the same variable node in a base graph being associated with similar channel reliabilities (e.g., by mapping them consistently to the MSB or LSB, for example), the SBPM scheme may improve a decoding threshold for a channel coding scheme, such as the QC-LDPC coding scheme described herein.

However, an SBPM scheme can result in performance degradation in some scenarios, such as high throughput scenarios (e.g., throughputs above 100 gigabits per second). For example, an SBPM scheme may result in degraded performance for transport block sizes near a switch point between two base graphs for an LDPC code. The switch point may be a threshold transport block size. For example, if a transport block has a size less than the threshold transport block size, a transmitter may encode the transport block using a first base graph. If the transport block has a size greater than the threshold transport block size, the transmitter may encode the transport block using a second base graph. For transport block sizes near the switch point, data encoded using the first base graph may experience worse performance (e.g., worse SNR performance) than data encoded using the second base graph (e.g., there may be a jump in performance near the switch point when switching to the second base graph). The jump or increase in performance may be caused by the SBPM scheme, rather than the LDPC encoding. Such jumps or increases in SNR performance may cause degraded performance for communications between the transmitter and the receiver because fluctuations in SNR conditions can cause degrade the decoding processing, increasing the risk of decoding errors, among other examples. Additionally, or alternatively, the SBPM scheme may be associated with a higher error floor (e.g., a higher minimum block error rate supported). For example, SBPM may result in degraded performance in low error rate scenarios. As another example, for a probabilistic shaping system that uses QC-LDPC codes, SBPM may be inapplicable because SBPM may result in parity bits being mapped to an LSB.

As indicated above, FIG. 6 is provided as an example. Other examples may differ from what is described with regard to FIG. 6.

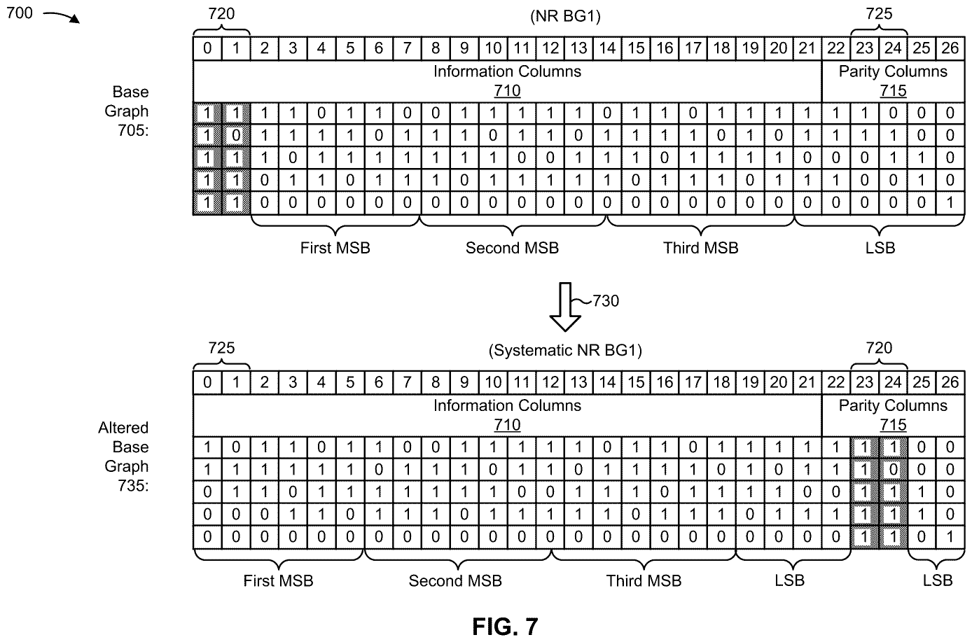

FIG. 7 is a diagram of an example 700 associated with an alteration of a base graph for an LDPC code. As shown in FIG. 7, one or more columns of a base graph 705 may be swapped to generate an altered base graph 735. FIG. 7 shows example PCMs for the base graph 705 and the altered base graph 735. The altered base graph 735 may be used for an encoding operation, such as the encoding operation performed by the transmitter 205 (e.g., via the LDPC encoder 220). In some examples, the base graph 705 may be defined in a wireless communications standard (such as 3GPP). For example, the base graph 705 may be an example of base graph 1 (BG1) as defined in 3GPP (e.g., technical specification (TS) 38.212, section 5.3.2, among other sections). In some examples, the base graph 705 may be one of a plurality of base graphs defined in the wireless communications standard. In some examples, the base graph 705 may be preconfigured at one or more of the transmitter 205 or the receiver 210 (e.g., as part of an original equipment manufacturer (OEM) configuration).

As shown in FIG. 7, the PCM for the base graph 705 may include one or more information columns 710 (e.g., that span from column index 0 to 21) and one or more parity columns 715 (e.g., that span from column index 22 to 26). In some examples, the information columns 710 may be examples of (or similar to) the information columns 410 and the parity columns 715 may be examples of (or similar to) the core parity columns 420. Additionally, the PCM for the base graph 705 may include a set of punctured columns 720, such as the punctured information columns 415. The set of punctured columns 720 may correspond to bits that are not transmitted, effectively increasing the code rate by reducing the number of transmitted bits. These punctured bits are inferred by the receiver during decoding using the redundancy provided by the other transmitted bits. Puncturing allows for flexible adaptation of the LDPC code to different data rates and channel conditions, enhancing the efficiency and robustness of the communication system. Additionally, the punctured columns may also be referred to herein as “punctured nodes” or “punctured variable nodes,” among other examples.

As shown in FIG. 7, various information columns 710 and parity columns 715 may be mapped to various bits of one or more constellation symbols. For example, the transmitter may perform a bit-to-symbol mapping procedure that maps the bits of the PCM (not included in the puncture columns 720) to each modulated symbol of a communication. As shown in FIG. 7, if the transmitter were to perform bit-to-symbol mapping on the base graph 705 (e.g., without altering the base graph 705), columns 2 to 7 may be mapped to an MSB in a modulation constellation, columns 8 to 14 may be mapped to a second MSB in the modulation constellation, columns 14 to 20 may be mapped to a third MSB in the modulation constellation, and columns 21 to 26 may be mapped to an LSB in the modulation constellation. In some examples, the bit-to-symbol mapping procedure may be an interleaving procedure (such as SBPM) such that the bits of the information columns 710 are mapped to the most significant bits of each modulated symbol and the parity columns are mapped to less significant bits of each modulated symbol.

As shown in FIG. 7, the transmitter may perform a base graph alteration 730 that swaps the set of punctured columns 720 with a set of parity columns 725. In some examples, the set of parity columns 725 may be examples of degree-2 parity columns (or degree-2 parity nodes) from the parity columns 715. As described elsewhere herein, each variable node has a degree that denotes the number of check nodes that the variable node is connected to in the base graph 705 (e.g., the number of rows with a positive value), where a degree-n variable node is connected to n check nodes. Additionally, the number of connections between a variable node and a number of check nodes may be indicated by the number of “1s” included in the column corresponding to the variable node. For instance, as shown in the base graph 705, columns 23, 24, and 25 included in the parity columns 715 each respectively include two “1s”. Therefore columns 23, 24, and 25 of the base graph 705 are degree-2 parity columns (or degree-2 parity nodes).

In example 700, the set of parity columns 725 includes column 23 and 24 of the base graph 705; however, in other examples, the set of parity columns may include any degree-2 parity columns of the base graph 705, such that the number of degree-2 parity columns included in the set of parity columns 725 is equal to the number of punctured columns in the set of punctured columns 720 (e.g., two punctured columns in example 700). For instance, in other examples, the set of parity columns 725 may include column 23 and 25 from the base graph 705 or include column 24 and 25 from the base graph 705. In some examples, the set of parity columns 725 may only contain degree-2 parity columns from the parity columns 715.

As part of the base graph alteration 730, the set of punctured columns 720 may be swapped with the set of parity columns 725 to generate the altered base graph 735. For instance, as shown in FIG. 7, column 23 is swapped with column 0 and column 24 is swapped with column 1. In some other examples, however, any punctured column from the set of punctured columns 720 may be swapped with any parity column from the set of parity columns 725. For instance, column 23 may be swapped with column 1 and column 24 may be swapped with column 0.

As shown in FIG. 7, after performing the base graph alteration 730, various portions of the PCM of the altered base graph 735 may be mapped to various bits of one or more constellation symbols. For example, with reference to the altered base graph 735, columns 0 to 5 may be mapped to an MSB in a modulation constellation, columns 6 to 12 may be mapped to a second MSB in the modulation constellation, columns 12 to 18 may be mapped to a third MSB in the modulation constellation, and columns 21 to 22, 25, and 26 may be mapped to an LSB in the modulation constellation (e.g., skipping the set of punctured columns 720). In some examples, the bit-to-symbol mapping procedure may be an interleaving procedure (such as SBPM) such that the bits of the information columns 710 are mapped to the most significant bits of each modulated symbol and the parity columns 715 are mapped to less significant bits of each modulated symbol.

In some examples, performing the base graph alteration 730 may optimize the error floor performance of LDPC codes by using a systematic code without compromising the threshold performance of interleaving procedures (such as SBPM). As described herein, the base graph alteration 730 involves swapping the punctured columns 720 with the degree-2 parity columns and ensuring that these degree-2 parity columns are mapped to the MSBs during the bit-to-symbol mapping procedure. For instance, in SBPM, the first nodes are typically mapped to the MSBs, which are less susceptible to noise and errors compared to the LSBs. Additionally, degree-2 parity nodes have fewer connections (compared to degree-3 parity nodes) and thus less redundancy. Therefore, by mapping these degree-2 parity nodes to the MSBs, the reliability is increased, which improves the overall decoding performance.

In the base graph 705 (e.g., the non-systematic NR BG1), the degree-2 chain (e.g., consisting of three degree-2 parity nodes in columns 23 through 25), was mapped to the LSBs. This mapping made these parity nodes more vulnerable to noise, thereby contributing to a higher error floor. In contrast, the altered base graph 735 (e.g., a systematic version of NR BG1) maps two out of the three degree-2 parity nodes to the MSB, enhancing the reliability and reducing the error floor associated with wireless communications. In some examples, using the altered base graph 735 to perform SBPM may maintain the same performance as using the base graph 705 for quadrature phase shift keying (QPSK). However, SBPM techniques may benefit from a reduced error floor using the altered base graph 735 for higher-order modulation schemes (such as one or more of 16-QAM, 64-QAM, 256-QAM, 1024-QAM, 4096-QAM, or probabilistic shaping, among other examples). This reduction in error floor may arise due to the distinct bit mapping strategies employed. By utilizing SBPM bit mapping, where parity bits are mapped to the LSBs, the altered base graph 735 leverages the enhanced reliability of the MSBs for the degree-2 parity nodes, thereby optimizing the error floor performance without adversely affecting the threshold. Consequently, mapping parity bits to MSBs improves the overall error correction performance of the LDPC code, leading to more robust and reliable communication.

As indicated above, FIG. 7 is provided as an example. Other examples may differ from what is described with regard to FIG. 7.

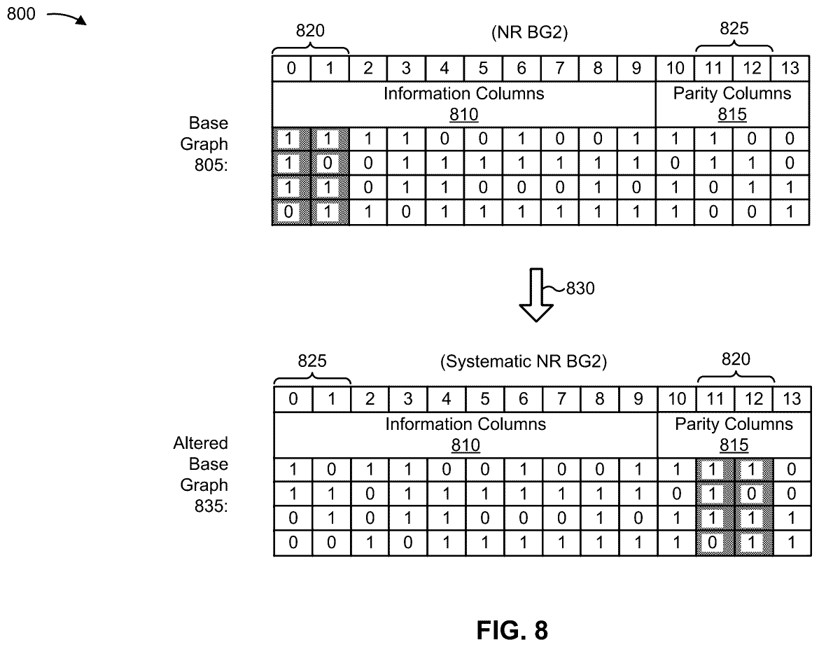

FIG. 8 is a diagram of an example 800 associated with an alteration of a base graph for an LDPC code. As shown in FIG. 8, one or more columns of a base graph 805 may be swapped to generate an altered base graph 835. FIG. 8 shows example PCMs for the base graph 805 and the altered base graph 835. The altered base graph 835 may be used for an encoding operation, such as the encoding operation performed by the transmitter 205 (e.g., via the LDPC encoder 220). In some examples, the base graph 805 may be defined in a wireless communications standard (such as 3GPP). For example, the base graph 805 may be an example of base graph 2 (BG2) as defined in 3GPP (e.g., TS 38.212, section 5.3.2, among other sections). In some examples, the base graph 805 may be one of a plurality of base graphs defined in the wireless communications standard. In some examples, the base graph 805 may be preconfigured at one or more of the transmitter 205 or the receiver 210 (e.g., as part of an original equipment manufacturer (OEM) configuration).

As shown in FIG. 8, the PCM for the base graph 805 may include one or more information columns 810 (e.g., that span from column index 0 to 9) and one or more parity columns 815 (e.g., that span from column index 10 to 13). In some examples, the information columns 810 may be examples of (or similar to) the information columns 410 and the parity columns 815 may be examples of (or similar to) the core parity columns 420. Additionally, the PCM for the base graph 805 may include a set of punctured columns 820, such as the punctured information columns 415.

As shown in FIG. 8, the transmitter may perform a base graph alteration 830 that swaps the set of punctured columns 820 with a set of parity columns 825. In some examples, the set of parity columns 825 may be examples of degree-2 parity columns (or degree-2 parity nodes) from the parity columns 815. For instance, as shown in the base graph 805, columns 11, 12, and 13 (included in the parity columns 815) each respectively include two “1” s. Therefore columns 11, 12, and 13 of the base graph 805 are degree-2 parity columns (or degree-2 parity nodes).

In example 800, the set of parity columns 825 includes column 11 and 12 of the base graph 805; however, in other examples, the set of parity columns may include any degree-2 parity columns of the base graph 805, such that the number of degree-2 parity columns included in the set of parity columns 825 is equal to the number of punctured columns in the set of punctured columns 820 (e.g., two punctured columns in example 800). For instance, in other examples, the set of parity columns 825 may include column 11 and 13 from the base graph 805 or include column 12 and 13 from the base graph 805. In some examples, the set of parity columns 825 may exclusively or only contain degree-2 parity columns from the parity columns 815.

As part of the base graph alteration 830, the set of punctured columns 820 may be swapped with the set of parity columns 825 to generate the altered base graph 835. For instance, as shown in FIG. 8, column 11 is swapped with column 0 and column 12 is swapped with column 1. In some other examples, however, any punctured column from the set of punctured columns 820 may be swapped with any parity column from the set of parity columns 825. For instance, column 11 may be swapped with column 1 and column 12 may be swapped with column 0.

Performing the base graph alteration 830 may optimize the error floor performance of LDPC codes by using a systematic code in a similar manner of performing base graph alteration 730, with reference to FIG. 7. In other words, base graph alteration 730 may alter the non-systematic NR BG1 to a systematic NR BG1 and the base graph alteration 830 may alter the non-systematic NR BG2 to a systematic NR BG2. In LDPC coding, BG1 and BG2 may be utilized based on the specific requirements of the communication system, as defined by a wireless communications standard (e.g., by the 3GPP). For instance, BG1 may be employed in scenarios where higher code rates are configured. Higher code rates may be advantageous in good channel conditions where the SNR is above an SNR threshold, allowing for efficient data transmission with less redundancy. This makes BG1 suitable for high data rate applications such as enhanced mobile broadband (eMBB) scenarios. Additionally, BG1 may be preferred over BG2 for shorter block lengths, which is beneficial in applications associated with low latency. Conversely, BG2 may be used in scenarios where lower code rates are required, providing more redundancy to ensure reliable communication in poor channel conditions. Lower code rates are essential when the SNR is less than the SNR threshold, and the channel conditions are challenging, as the increased redundancy helps in error correction. BG2 may be preferred over BG1 in low data rate applications, such as massive machine-type communications (mMTC) and ultra-reliable low-latency communications (URLLC), where robustness and reliability are more important than high throughput. Furthermore, BG2 may be more efficient than BG1 for longer block lengths. Therefore, by implementing the base graph alteration 730 and the base graph alteration 730, the transmitter and receiver may benefit from improvements in error correction performance of the LDPC code, leading to more robust and reliable communication for both higher and lower code rates.

As indicated above, FIG. 8 is provided as an example. Other examples may differ from what is described with regard to FIG. 8.

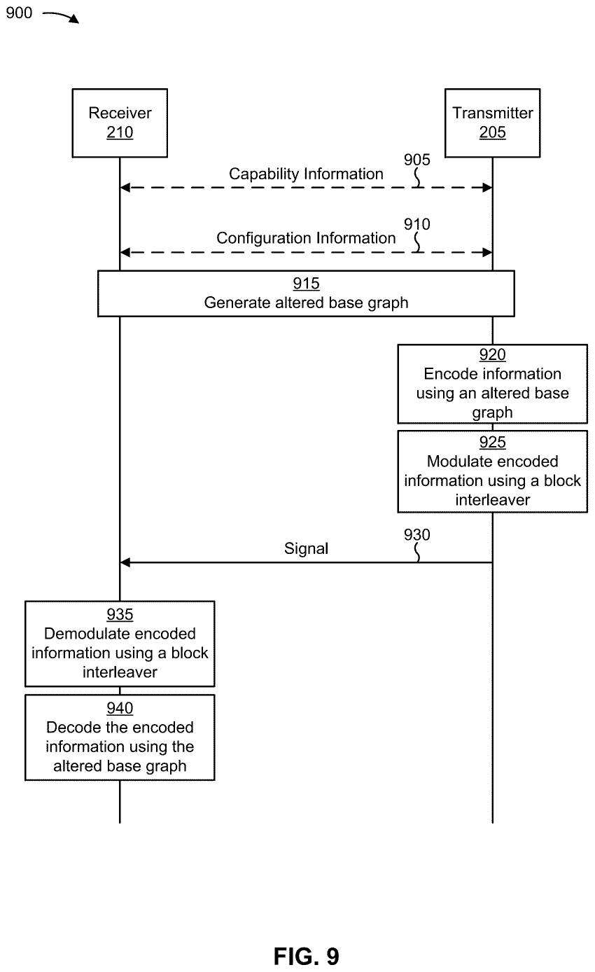

FIG. 9 is a diagram illustrating an example 900 associated with signaling that enables an altered base graph for LDPC code. In some examples, the LDPC code may be a QC-LDPC code. Example 900 may implement or be implemented by one or more aspects of FIGS. 1 through 8. For instance, example 900 includes wireless communications between the transmitter 205 and the receiver 210. Alternative examples of the following operations may be implemented, where some operations are performed in a different order than described, or not described at all. In some cases, one or more operations may include additional features not mentioned below, or further operations may be added. In addition, while example 900 shows operations between the transmitter 205 and the receiver 210, the communication may occur between any number of network devices of various types described herein.

In a first operation 905, the transmitter 205 may optionally communicate, with the receiver 210, capability information. For example, if the transmitter 205 is a UE 120 and the receiver 210 is a network node 110 or a second UE 120, then the transmitter 205 may transmit, and the receiver 210 may receive, the capability information. Alternatively, if the receiver 210 is a UE 120 and the transmitter 205 is a network node 110 or a second UE 120, then the receiver 210 may transmit, and the transmitter 205 may receive, the capability information.

The capability information may be included in a capability report. The transmitter 205 and the receiver 210 may communicate the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a sidelink channel (e.g., a physical sidelink control channel (PSCCH), or a physical sidelink shared channel (PSSCH)), among other examples. The capability information may indicate one or more parameters associated with respective capabilities of the transmitter 205 or the receiver 210. The one or more parameters may be indicated via respective information elements (IEs) included in a capability report.

The capability information may indicate whether the receiver 210 or the transmitter 205 supports a feature or one or more parameters related to the feature. For example, the capability information may indicate a capability or parameter that the transmitter 205 or the receiver 210 supports, using an altered version of a base graph for encoding and decoding one or more wireless communications (e.g., the altered base graph 735 or 835). In other words, the capability information may indicate that the transmitter 205 or the receiver 210 is capable of operating in accordance with an altered base graph for LDPC decoding that includes a set of punctured nodes that are swapped with a set of parity nodes from an unaltered version of the base graph.

The transmitter 205 or the receiver 210 may determine configuration information based on the capability information.

In a second operation 910, the transmitter 205 may optionally communicate, with the receiver 210, configuration information in accordance with the capability information. For example, if the transmitter 205 transmitted the capability information, then the receiver 210 may transmit, and the transmitter 205 may receive, the configuration information. Alternatively, if the receiver 210 transmitted the capability information, then the transmitter 205 may transmit, and the receiver 210 may receive, the configuration information. In some aspects, the transmitter 205 and the receiver 210 may communicate the configuration information via one or more of system information signaling (e.g., a master information block (MIB) or a SIB, among other examples), RRC signaling, MAC signaling (e.g., one or more MAC-CEs), or DCI, among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled. For example, in some aspects, the configuration information may at least partially be defined by a wireless communication standard, such as the 3GPP. In such examples, the transmitter 205 or the receiver 210 may not explicitly indicate such configuration information to the receiver 210 or transmitter 205. For example, the receiver 210 or transmitter 205 may optionally obtain at least a portion of the configuration information from a configuration stored by the receiver 210 or transmitter 205 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information may indicate the base graph from multiple base graphs to use for LDPC coding. For example, the configuration information may explicitly indicate the base graph from multiple base graphs (e.g., indicate one of NR BG1 or NR BG2). Alternatively, the configuration information may implicitly indicate the base graph from multiple base graphs by indicating another parameter. For example, the configuration information may indicate an MCS for one or more wireless communications, where the code rate of the MCS points to one of NR BG1, NR BG2, or some other base graph.

Additionally, or alternatively, the configuration information may indicate to operate in accordance with the altered version of the base graph (e.g., indicate to perform base graph alteration 730 for the base graph 705 or to perform base graph alteration 830 for the base graph 805). For example, the configuration information may include a value (such as a bit value), where a first value indicates to use an altered version of the base graph and a second value indicates to use an unaltered version of the base graph.

In a third operation 915, one or more of the transmitter 205 or the receiver 210 may generate the altered base graph. For example, the transmitter 205 or the receiver 210 may swap a set of punctured nodes (or punctured columns) with a set of parity nodes (or parity columns) from the unaltered version of the base graph. If the base graph is the base graph 705 (e.g., NR BG1), then the transmitter 205 or the receiver 210 may perform the base graph alteration 730 to swap the punctured columns 720 of the base graph 705 with the set of parity columns 725 to generate the altered base graph 735 (e.g., the systematic NR BG1). If the base graph is the base graph 805 (e.g., NR BG2), then the transmitter 205 or the receiver 210 may perform the base graph alteration 830 to swap the punctured columns 820 of the base graph 805 with the set of parity columns 825 to generate the altered base graph 835 (e.g., the systematic NR BG2).

As described elsewhere herein, the set of parity nodes (e.g., the set of parity columns 725 or 825) may contain only degree-2 parity nodes. In some examples, the set of parity nodes maintain a set of cyclic shifts after being swapped with the set of punctured nodes. For example, in a QC-LDPC code, each edge in the base graph may have a cyclic shift value such that each parity node from the set of parity nodes may be associated with a cyclic shift value for each corresponding edge. Accordingly, each parity node from the set of parity nodes maintains the same set of cyclic shifts after being swapped.

In some examples, the transmitter 205 or the receiver 210 may store the altered version of the base graph to associated memory or may be pre-configured with the altered version of the base graph (e.g., as part of an OEM configuration). In some examples, the transmitter 205 or the receiver 210 may generate the altered base graph based on one or more of the capability information (in the first operation 905) or the configuration information (in the second operation 910).

In a fourth operation 920, the transmitter 205 may encode, using the altered version of a base graph for an LDPC code, first information to obtain encoded information. In some aspects, the transmitter 205 may expand the altered base graph through a lifting operation, where each entry in the altered base graph is replaced by a larger matrix, such as a circulant permutation matrix. The lifting operation creates a larger, QC-LDPC code that retains the structural properties of the altered base graph while increasing the length and complexity (e.g., as described with reference to FIG. 4).

In a fifth operation 925, the transmitter 205 may modulate the encoded information to map the encoded information to one or more constellation symbols. In some examples, the encoded information is modulated in accordance with an interleaving procedure (e.g., an SBPM procedure) as described elsewhere herein (e.g., described with reference to FIG. 6).

In some examples, modulating the encoded information includes mapping a systematic portion of the encoded information to more significant bit positions within the one or more constellation symbols compared to a non-systematic portion of the encoded information. Additionally, the set of parity nodes may be included in the systematic portion based on being swapped with the set of punctured nodes. Placing the set of parity nodes at the beginning of the base graph can improve bit-to-constellation mapping and improving the error floor performance by improving the likelihood that such parity columns are mapped to MSBs in constellation symbols.

In a sixth operation 930, the transmitter 205 may transmit, and the receiver 210 may receive, a signal that indicates second information that is based on the one or more constellation symbols. For example, the transmitter 205 may convert the modulated constellation symbols into an RF signal that can be propagated through the wireless communication channel.

The receiver 210 may receive the signal. The receiver 210 may perform RF processing to obtain the encoded information. For example, the receiver 210 may convert the received RF signal into baseband signals, which may include down-converting the signal frequency, filtering, and amplifying the signal to prepare the signal for further processing.

In a seventh operation 935, the receiver 210 may demodulate the encoded information using a block interleaver, such as a depth-m block de-interleaver or SBPM de-interleaver. The demodulation operation may include the receiver 210 mapping the received constellation symbols back to corresponding encoded bits. The block interleaver enables the receiver 210 to rearrange the bits in a pattern that mitigates the effects of burst errors and ensures that bits with different levels of reliability are appropriately distributed, as described elsewhere herein.

In an eighth operation 940, the receiver 210 may decode the encoded information to obtain decoded information (e.g., information bits). For example, the receiver 210 may decode the encoded information using an LDPC decoder, such as the LDPC decoder 230. The LDPC decoder may operate by iteratively solving the parity-check equations defined by the altered base graph.

The receiver 210 may decode the encoded information based on the altered base graph. For example, the receiver 210 may use the altered base graph that has swapped parity nodes and punctured nodes, in a similar manner as described elsewhere herein. For example, the receiver 210 may take into account the altered version of the base graph that was applied during the encoding process. By doing so, the receiver 210 can accurately interpret the structure of the encoded bits and effectively correct any errors that may have occurred during transmission. This enables the LDPC code to maintain high error correction performance when the permutation pattern has been used to enhance the reliability of one or more bits within the modulation constellation.

As indicated above, FIG. 9 is provided as an example. Other examples may differ from what is described with regard to FIG. 9.

FIG. 10 is a diagram illustrating an example process 1000 performed, for example, at a transmitter device or an apparatus of a transmitter device. Example process 1000 is an example where the apparatus or the transmitter device (e.g., transmitter 205) performs operations associated with altered base graph for LDPC code.

As shown in FIG. 10, in some aspects, process 1000 may include encoding, using an altered version of a base graph for an LDPC code, first information to obtain encoded information, wherein the altered version of the base graph includes a set of punctured nodes that are swapped with a set of parity nodes from an unaltered version of the base graph (block 1010). For example, the transmitter device (e.g., using communication manager 1206, depicted in FIG. 12) may encode, using an altered version of a base graph for an LDPC code, first information to obtain encoded information, wherein the altered version of the base graph includes a set of punctured nodes that are swapped with a set of parity nodes from an unaltered version of the base graph, as described above.

As further shown in FIG. 10, in some aspects, process 1000 may include modulating the encoded information to map the encoded information to one or more constellation symbols (block 1020). For example, the transmitter device (e.g., using communication manager 1206, depicted in FIG. 12) may modulate the encoded information to map the encoded information to one or more constellation symbols, as described above.

As further shown in FIG. 10, in some aspects, process 1000 may include transmitting, to a receiver device, a signal that indicates second information that is based at least in part on the one or more constellation symbols (block 1030). For example, the transmitter device (e.g., using transmission component 1204 or communication manager 1206, depicted in FIG. 12) may transmit, to a receiver device, a signal that indicates second information that is based at least in part on the one or more constellation symbols, as described above.

Process 1000 may include additional aspects, such as any single aspect or any combination of aspects described below or in connection with one or more other processes described elsewhere herein.

In a first aspect, process 1000 includes communicating, with the receiver device, capability information that indicates support for using the altered version of the base graph for encoding and decoding one or more wireless communications, where encoding using the altered version of the base graph is based at least in part on the capability information.

In a second aspect, alone or in combination with the first aspect, process 1000 includes communicating, with the receiver device, configuration information that indicates the base graph from multiple base graphs and indicates to operate in accordance with the altered version of the base graph.

In a third aspect, alone or in combination with one or more of the first and second aspects, the set of parity nodes contains only degree-2 parity nodes.

In a fourth aspect, alone or in combination with one or more of the first through third aspects, the set of parity nodes are mapped to a most significant bit of the one or more constellation symbols based at least in part on being swapped with the set of punctured nodes.

In a fifth aspect, alone or in combination with one or more of the first through fourth aspects, the set of parity nodes maintain a set of cyclic shifts after being swapped with the set of punctured nodes.

In a sixth aspect, alone or in combination with one or more of the first through fifth aspects, modulating the encoded information further comprises mapping a systematic portion of the encoded information to more significant bit positions within the one or more constellation symbols compared to a non-systematic portion of the encoded information, where the set of parity nodes are included in the systematic portion based at least in part on being swapped with the set of punctured nodes.

In a seventh aspect, alone or in combination with one or more of the first through sixth aspects, the LDPC code is a QC-LDPC code.

In an eighth aspect, alone or in combination with one or more of the first through seventh aspects, the encoded information is modulated in accordance with a SBPM procedure.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a receiver device or an apparatus of a receiver device. Example process 1100 is an example where the apparatus or the receiver device (e.g., receiver 210) performs operations associated with altered base graph for LDPC code.

As shown in FIG. 11, in some aspects, process 1100 may include receiving, from a transmitter device, a signal that indicates second information associated with one or more constellation symbols (block 1110). For example, the receiver device (e.g., using reception component 1302 or communication manager 1306, depicted in FIG. 13) may receive, from a transmitter device, a signal that indicates second information associated with one or more constellation symbols, as described above.

As further shown in FIG. 11, in some aspects, process 1100 may include demodulating, based on the one or more constellation symbols, the second information to obtain encoded information (block 1120). For example, the receiver device (e.g., using communication manager 1306, depicted in FIG. 13) may demodulate, based on the one or more constellation symbols, the second information to obtain encoded information, as described above.

As further shown in FIG. 11, in some aspects, process 1100 may include decoding, using an altered version of a base graph for an LDPC code, the encoded information to obtain first information, where the altered version of the base graph includes a set of punctured nodes that are swapped with a set of parity nodes from an unaltered version of the base graph (block 1130). For example, the receiver device (e.g., using communication manager 1306, depicted in FIG. 13) may decode, using an altered version of a base graph for an LDPC code, the encoded information to obtain first information, where the altered version of the base graph includes a set of punctured nodes that are swapped with a set of parity nodes from an unaltered version of the base graph, as described above.

Process 1100 may include additional aspects, such as any single aspect or any combination of aspects described below or in connection with one or more other processes described elsewhere herein.

In a first aspect, process 1100 includes communicating, with the transmitter device, capability information that indicates support for using the altered version of the base graph for encoding and decoding one or more wireless communications, where decoding using the altered version of the base graph is based at least in part on the capability information.

In a second aspect, alone or in combination with the first aspect, process 1100 includes communicating, with the transmitter device, configuration information that indicates the base graph from multiple base graphs and indicates to operate in accordance with the altered version of the base graph.

In a third aspect, alone or in combination with one or more of the first and second aspects, the set of parity nodes contains only degree-2 parity nodes.

In a fourth aspect, alone or in combination with one or more of the first through third aspects, the set of parity nodes are mapped to a most significant bit of the one or more constellation symbols based at least in part on being swapped with the set of punctured nodes.

In a fifth aspect, alone or in combination with one or more of the first through fourth aspects, the set of parity nodes maintain a set of cyclic shifts after being swapped with the set of punctured nodes.

In a sixth aspect, alone or in combination with one or more of the first through fifth aspects, the LDPC code is a QC-LDPC code.

In a seventh aspect, alone or in combination with one or more of the first through sixth aspects, the encoded information is demodulated in accordance with a SBPM procedure.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a transmitter device, or a transmitter device may include the apparatus 1200. In some aspects, the apparatus 1200 includes a reception component 1202, a transmission component 1204, or a communication manager 1206, which may be in communication with one another (for example, via one or more buses or one or more other components). In some aspects, the communication manager 1206 is the communication manager 150 or 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 140 or 145 described in connection with FIG. 1) of the transmitter device.

In some aspects, the apparatus 1200 may be configured to perform one or more operations described herein in connection with FIGS. 2 through 9. Additionally, or alternatively, the apparatus 1200 may be configured to perform one or more processes described herein, such as process 1000 of FIG. 10 In some aspects, the apparatus 1200 or one or more components shown in FIG. 12 may include one or more components of the transmitter device described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the transmitter device described above in connection with FIG. 1, such as a radio, one or more RF chains, one or more transceivers, or one or more modems, each of which may in turn be coupled with one or more antennas of the transmitter device.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the transmitter device described above in connection with FIG. 1, such as a radio, one or more RF chains, one or more transceivers, or one or more modems, each of which may in turn be coupled with one or more antennas of the transmitter device described in connection with FIG. 1. In some aspects, the transmission component 1204 may be co-located with the reception component 1202.

The communication manager 1206 may support operations of the reception component 1202 or the transmission component 1204. For example, the communication manager 1206 may receive information associated with configuring reception of communications by the reception component 1202 or transmission of communications by the transmission component 1204. Additionally, or alternatively, the communication manager 1206 may generate or provide control information to the reception component 1202 or the transmission component 1204 to control reception or transmission of communications.

The communication manager 1206 may encode, using an altered version of a base graph for an LDPC code, first information to obtain encoded information, where the altered version of the base graph includes a set of punctured nodes that are swapped with a set of parity nodes from an unaltered version of the base graph. The communication manager 1206 may modulate the encoded information to map the encoded information to one or more constellation symbols. The transmission component 1204 may transmit, to a receiver device, a signal that indicates second information that is based at least in part on the one or more constellation symbols.

The communication manager 1206 may communicate, with the receiver device, capability information that indicates support for using the altered version of the base graph for encoding and decoding one or more wireless communications, where encoding using the altered version of the base graph is based at least in part on the capability information.

The communication manager 1206 may communicate, with the receiver device, configuration information that indicates the base graph from multiple base graphs and indicates to operate in accordance with the altered version of the base graph.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a receiver device, or a receiver device may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 150 or 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 or 145 described in connection with FIG. 1) of the receiver device.

In some aspects, the apparatus 1300 may be configured to perform one or more operations described herein in connection with FIGS. 2 through 9. Additionally, or alternatively, the apparatus 1300 may be configured to perform one or more processes described herein, such as process 1100 of FIG. 11. In some aspects, the apparatus 1300 or one or more components shown in FIG. 13 may include one or more components of the receiver device described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the receiver device described above in connection with FIG. 1, such as a radio, one or more RF chains, one or more transceivers, or one or more modems, each of which may in turn be coupled with one or more antennas of the receiver device.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the receiver device described above in connection with FIG. 1, such as a radio, one or more RF chains, one or more transceivers, or one or more modems, each of which may in turn be coupled with one or more antennas of the receiver device described in connection with FIG. 1. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The reception component 1302 may receive, from a transmitter device, a signal that indicates second information associated with one or more constellation symbols. The communication manager 1306 may demodulate, based on the one or more constellation symbols, the second information to obtain encoded information. The communication manager 1306 may decode, using an altered version of a base graph for an LDPC code, the encoded information to obtain first information, where the altered version of the base graph includes a set of punctured nodes that are swapped with a set of parity nodes from an unaltered version of the base graph.

The communication manager 1306 may communicate, with the transmitter device, capability information that indicates support for using the altered version of the base graph for encoding and decoding one or more wireless communications, where decoding using the altered version of the base graph is based at least in part on the capability information.

The communication manager 1306 may communicate, with the transmitter device, configuration information that indicates the base graph from multiple base graphs and indicates to operate in accordance with the altered version of the base graph.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a transmitter device, comprising: encoding, using an altered version of a base graph for a low-density parity-check code, first information to obtain encoded information, wherein the altered version of the base graph includes a set of punctured nodes that are swapped with a set of parity nodes from an unaltered version of the base graph; modulating the encoded information to map the encoded information to one or more constellation symbols; and transmitting, to a receiver device, a signal that indicates second information that is based at least in part on the one or more constellation symbols.

Aspect 2: The method of Aspect 1, further comprising: communicating, with the receiver device, capability information that indicates support for using the altered version of the base graph for encoding and decoding one or more wireless communications, wherein encoding using the altered version of the base graph is based at least in part on the capability information.

Aspect 3: The method of any of Aspects 1-2, further comprising: communicating, with the receiver device, configuration information that indicates the base graph from multiple base graphs and indicates to operate in accordance with the altered version of the base graph.

Aspect 4: The method of any of Aspects 1-3, wherein the set of parity nodes contains only degree-2 parity nodes.

Aspect 5: The method of any of Aspects 1-4, wherein the set of parity nodes are mapped to a most significant bit of the one or more constellation symbols based at least in part on being swapped with the set of punctured nodes.

Aspect 6: The method of any of Aspects 1-5, wherein the set of parity nodes maintain a set of cyclic shifts after being swapped with the set of punctured nodes.

Aspect 7: The method of any of Aspects 1-6, wherein modulating the encoded information further comprises: mapping a systematic portion of the encoded information to more significant bit positions within the one or more constellation symbols compared to a non-systematic portion of the encoded information, wherein the set of parity nodes are included in the systematic portion based at least in part on being swapped with the set of punctured nodes.

Aspect 8: The method of any of Aspects 1-7, wherein the low-density parity-check code is a quasi-cyclic low-density parity-check code.

Aspect 9: The method of any of Aspects 1-8, wherein the encoded information is modulated in accordance with a systematic bit priority mapping procedure.

Aspect 10: A method of wireless communication performed by a receiver device, comprising: receiving, from a transmitter device, a signal that indicates second information associated with one or more constellation symbols; demodulating, based on the one or more constellation symbols, the second information to obtain encoded information; and decoding, using an altered version of a base graph for a low-density parity-check code, the encoded information to obtain first information, wherein the altered version of the base graph includes a set of punctured nodes that are swapped with a set of parity nodes from an unaltered version of the base graph.

Aspect 11: The method of Aspect 10, further comprising: communicating, with the transmitter device, capability information that indicates support for using the altered version of the base graph for encoding and decoding one or more wireless communications, wherein decoding using the altered version of the base graph is based at least in part on the capability information.

Aspect 12: The method of any of Aspects 10-11, further comprising: communicating, with the transmitter device, configuration information that indicates the base graph from multiple base graphs and indicates to operate in accordance with the altered version of the base graph.

Aspect 13: The method of any of Aspects 10-12, wherein the set of parity nodes contains only degree-2 parity nodes.

Aspect 14: The method of any of Aspects 10-13, wherein the set of parity nodes are mapped to a most significant bit of the one or more constellation symbols based at least in part on being swapped with the set of punctured nodes.

Aspect 15: The method of any of Aspects 10-14, wherein the set of parity nodes maintain a set of cyclic shifts after being swapped with the set of punctured nodes.

Aspect 16: The method of any of Aspects 10-15, wherein the low-density parity-check code is a quasi-cyclic low-density parity-check code.

Aspect 17: The method of any of Aspects 10-16, wherein the encoded information is demodulated in accordance with a systematic bit priority mapping procedure.

Aspect 18: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-17.

Aspect 19: An apparatus for wireless communication at a device, the apparatus comprising one or more memories and one or more processors coupled to the one or more memories, the one or more processors configured to cause the device to perform the method of one or more of Aspects 1-17.

Aspect 20: An apparatus for wireless communication, the apparatus comprising at least one means for performing the method of one or more of Aspects 1-17.

Aspect 21: A non-transitory computer-readable medium storing code for wireless communication, the code comprising instructions executable by one or more processors to perform the method of one or more of Aspects 1-17.

Aspect 22: A non-transitory computer-readable medium storing a set of instructions for wireless communication, the set of instructions comprising one or more instructions that, when executed by one or more processors of a device, cause the device to perform the method of one or more of Aspects 1-17.

Aspect 23: A device for wireless communication, the device comprising a processing system that includes one or more processors and one or more memories coupled with the one or more processors, the processing system configured to cause the device to perform the method of one or more of Aspects 1-17.

Aspect 24: An apparatus for wireless communication at a device, the apparatus comprising one or more memories and one or more processors coupled to the one or more memories, the one or more processors individually or collectively configured to cause the device to perform the method of one or more of Aspects 1-17.

Aspect 25: A device comprising a processing system that includes one or more processors and one or more code-storing memories coupled with the one or more processors, the processing system configured to cause the device to perform the method of one or more of Aspects 1-17.

Aspect 26: A device comprising a processing system that includes processor circuitry and code-storing memory circuitry, the processing system configured to cause the device to perform the method of one or more of Aspects 1-17.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s).

Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A transmitter device for wireless communication, comprising:
one or more memories; and
one or more processors, coupled to the one or more memories, configured to cause the transmitter device to:
encode, using an altered version of a base graph for a low-density parity-check code, first information to obtain encoded information, wherein the altered version of the base graph includes a set of punctured nodes that are swapped with a set of parity nodes from an unaltered version of the base graph;
modulate the encoded information to map the encoded information to one or more constellation symbols; and
transmit, to a receiver device, a signal that indicates second information that is based at least in part on the one or more constellation symbols.

2. The transmitter device of claim 1, wherein the one or more processors are further configured to cause the transmitter device to:
communicate, with the receiver device, capability information that indicates support for using the altered version of the base graph for encoding and decoding one or more wireless communications, wherein encoding using the altered version of the base graph is based at least in part on the capability information.

3. The transmitter device of claim 1, wherein the one or more processors are further configured to cause the transmitter device to:
communicate, with the receiver device, configuration information that indicates the base graph from multiple base graphs and indicates to operate in accordance with the altered version of the base graph.

4. The transmitter device of claim 1, wherein the set of parity nodes contains only degree-2 parity nodes.

5. The transmitter device of claim 1, wherein the set of parity nodes are mapped to a most significant bit of the one or more constellation symbols based at least in part on being swapped with the set of punctured nodes.

6. The transmitter device of claim 1, wherein the set of parity nodes maintain a set of cyclic shifts after being swapped with the set of punctured nodes.

7. The transmitter device of claim 1, wherein to modulate the encoded information, the one or more processors are configured to cause the transmitter device to:
map a systematic portion of the encoded information to more significant bit positions within the one or more constellation symbols compared to a non-systematic portion of the encoded information, wherein the set of parity nodes are included in the systematic portion based at least in part on being swapped with the set of punctured nodes.

8. The transmitter device of claim 1, wherein the low-density parity-check code is a quasi-cyclic low-density parity-check code.

9. The transmitter device of claim 1, wherein the encoded information is modulated in accordance with a systematic bit priority mapping procedure.

10. A method of wireless communication performed by a transmitter device, comprising:
encoding, using an altered version of a base graph for a low-density parity-check code, first information to obtain encoded information, wherein the altered version of the base graph includes a set of punctured nodes that are swapped with a set of parity nodes from an unaltered version of the base graph;
modulating the encoded information to map the encoded information to one or more constellation symbols; and
transmitting, to a receiver device, a signal that indicates second information that is based at least in part on the one or more constellation symbols.

11. The method of claim 10, further comprising:
communicating, with the receiver device, capability information that indicates support for using the altered version of the base graph for encoding and decoding one or more wireless communications, wherein encoding using the altered version of the base graph is based at least in part on the capability information.

12. The method of claim 10, further comprising:
communicating, with the receiver device, configuration information that indicates the base graph from multiple base graphs and indicates to operate in accordance with the altered version of the base graph.

13. The method of claim 10, wherein the set of parity nodes contains only degree-2 parity nodes.

14. The method of claim 10, wherein the set of parity nodes are mapped to a most significant bit of the one or more constellation symbols based at least in part on being swapped with the set of punctured nodes.

15. The method of claim 10, wherein the set of parity nodes maintain a set of cyclic shifts after being swapped with the set of punctured nodes.

16. The method of claim 10, wherein modulating the encoded information comprises:
mapping a systematic portion of the encoded information to more significant bit positions within the one or more constellation symbols compared to a non-systematic portion of the encoded information, wherein the set of parity nodes are included in the systematic portion based at least in part on being swapped with the set of punctured nodes.

17. The method of claim 10, wherein the low-density parity-check code is a quasi-cyclic low-density parity-check code.

18. The method of claim 10, wherein the encoded information is modulated in accordance with a systematic bit priority mapping procedure.

19. An apparatus for wireless communication, comprising:
means for encoding, using an altered version of a base graph for a low-density parity-check code, first information to obtain encoded information, wherein the altered version of the base graph includes a set of punctured nodes that are swapped with a set of parity nodes from an unaltered version of the base graph;
means for modulating the encoded information to map the encoded information to one or more constellation symbols; and
means for transmitting, to a receiver device, a signal that indicates second information that is based at least in part on the one or more constellation symbols.

20. The apparatus of claim 19, further comprising:
means for communicating, with the receiver device, capability information that indicates support for using the altered version of the base graph for encoding and decoding one or more wireless communications, wherein encoding using the altered version of the base graph is based at least in part on the capability information.
